(19) United States
(12) Patent Application Publication
(10) Pub. No.: US 2006/0109354 A1
(43) Pub. Date: May 25, 2006

(54) Mobile communication terminal for controlling a zoom function and a method thereof

(75) Inventor: Woo-Sun Yoon, Gumi-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co.,Ltd.

(21) Appl. No.: 11/116,311

(22) Filed: Apr. 28, 2005

(30) Foreign Application Priority Data
Nov. 23, 2004 (KR) 2004-96615

(51) Int. Cl. H04N 5/262

(52) U.S. Cl. 348/240.99

(57) ABSTRACT

An apparatus and method for controlling a zoom function of positively or negatively magnifying an image in a mobile communication terminal having a camera. The apparatus and method include registering predetermined keys such that the keys are uniquely mapped to zoom levels of the camera; and if any one of the registered keys is input in a camera mode of the mobile communication terminal, adjusting a zoom magnification to a zoom level corresponding to the input key. Accordingly, a user can easily control a zoom magnification by pushing a number key once without having to continuously push a zoom control key in a camera mode. In the mobile communication terminal, a zoom control can be performed by pushing number keys used in the mobile communication terminal without using a separate key for zoom control.

### PRIORITY

This application claims the benefit under 35 U.S.C. § 119(a) of an application entitled “Mobile Communication Terminal for Controlling Zoom Function and Method Thereof” filed in the Korean Intellectual Property Office on Nov. 23, 2004 and assigned Serial No. 2004-96615, the entire contents of which are incorporated herein by reference.

### BACKGROUND OF THE INVENTION

1. Field of the Invention

The present invention relates generally to a mobile communication terminal having a camera. In particular, the present invention relates to a mobile communication terminal for controlling a zoom function by which a positively or negatively magnified image can be captured, and a method thereof.

2. Description of the Related Art

A mobile communication terminal is a device for providing a communication function by which a telephone call can be performed or data can be exchanged while a user is on the move, such as a cellular phone, a personal digital assistant (PDA), a personal communication service (PCS) phone, an International Mobile Telecommunication (IMT)-2000 terminal, and a Global System for Mobile Communication (GSM) terminal.

The mobile communication terminal is a device commonly used all over the world without distinction of age or sex and is being recognized as a necessity. Accordingly, the mobile communication terminal tends to be small, slim, and light-weight considering its portability, and is evolving into a device that can provide a variety of functions. In particular, a future mobile communication terminal will smaller, a multi-function and multi-purpose terminal, and modified to be adapted to a variety of multimedia or Internet environments.

Recently, the mobile communication terminal has become a device in which data can be transmitted at a high data rate besides a voice communication function, since the voice communication and the high-speed data communication can be realized using the mobile communication terminal when an IMT-2000 mobile communication network is constructed. The data, which can be processed by the mobile communication terminal performing the data communication, may be classified into packet data and image data. A function of displaying a moving picture is being realized by adding a camera or a TV receiver to the mobile communication terminal. Therefore, the mobile communication terminal having a camera can take images, display the images as a moving picture or still images, and transmit the taken images. In addition, the mobile communication terminal having a camera provides a function of positively and negatively magnifying an image to be taken by having a zoom function.

The mobile communication terminal having the zoom function such as optical 3× zoom, optical 5× zoom, or digital zoom can control the zoom function using 6 to 7 levels of “WIDE” to “TELE” in a preview state. In this manner, when a user desires to take a magnified picture, the user controls a zoom magnification by pushing a “WIDE” key or a “TELE” key. In this method, in order for the user to adjust the zoom function to a desired zoom level, the user should inconveniently continuously push the “WIDE” key or “TELE” key.

### SUMMARY OF THE INVENTION

An object of the present invention is to substantially solve at least the above problems and/or disadvantages and to provide at least the advantages below. Accordingly, an object of the present invention is to provide a mobile communication terminal having a camera for easily controlling zoom levels when a user uses a zoom function therein, and a zoom function control method thereof.

Another object of the present invention is to provide a mobile communication terminal having a camera for controlling zoom levels without continuously inputting a zoom control key when a user uses a zoom function therein, and a method thereof.

A further object of the present invention is to provide a mobile communication terminal for controlling zoom levels without a separate zoom control key, and a method thereof.

According to one aspect of the present invention, there is provided a method for controlling a zoom function of positively or negatively magnifying an image in a mobile communication terminal having a camera. The method comprises the steps of registering predetermined keys such that the keys are uniquely mapped to zoom levels of the camera; and if any one of the registered keys is input in a camera mode of the mobile communication terminal, adjusting a zoom magnification to a zoom level corresponding to the input key.

According to another aspect of the present invention, there is provided a mobile communication terminal having a camera. The mobile communication terminal comprises a camera module comprising a retractable lens module, for capturing image data through the lens module; a memory for storing table information in which predetermined keys are uniquely mapped to zoom levels of the lens module; and a controller for, if any one of the predetermined keys stored in the memory is input in a camera mode, adjusting a zoom magnification to a zoom level corresponding to the input predetermined key.

### BRIEF DESCRIPTION OF THE DRAWINGS

The above and other objects, features and advantages of the present invention will become more apparent from the following detailed description when taken in conjunction with the accompanying drawings in which:

FIG. 1 is a top perspective view of a mobile communication terminal according to an embodiment of the present invention;

FIG. 2 is a top view of a side of the mobile communication terminal according to an embodiment of the present invention;

FIG. 3 is a schematic block diagram of the mobile communication terminal according to an embodiment of the present invention; and

FIG. 4 is a flowchart illustrating a process of controlling a zoom function of the mobile communication terminal according to an embodiment of the present invention.

Throughout the drawings, the same element is designated by the same reference numeral or character.

### DETAILED DESCRIPTION OF AN EXEMPLARY EMBODIMENT

An embodiment of the present invention will be described herein below with reference to the accompanying drawings. In the drawings, the same or similar elements are denoted by the same reference numerals even though they are depicted in different drawings. In the following description, well-known functions or constructions are not described in detail for conciseness.

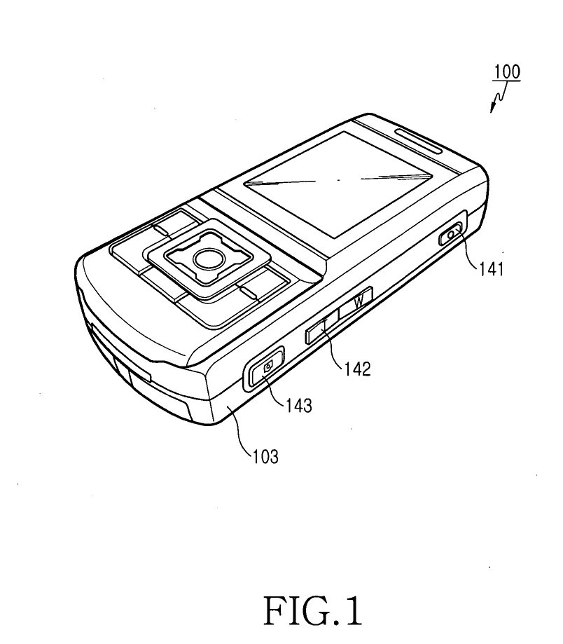

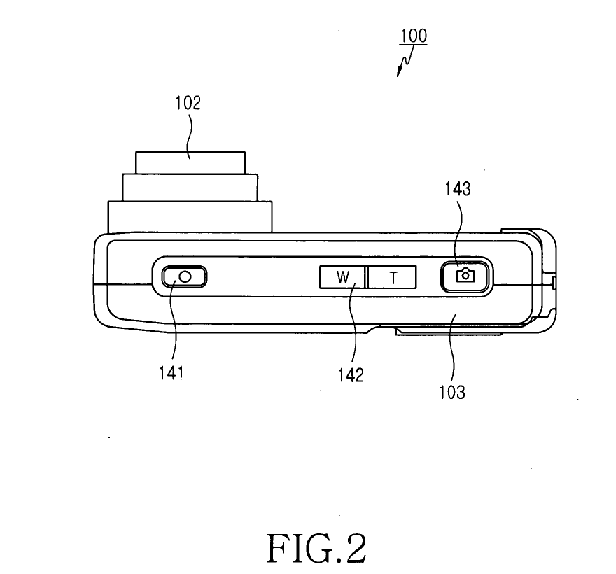

FIG. 1 is a top perspective view of a mobile communication terminal 100 according to an embodiment of the present invention. FIG. 2 is a top view of a side of the mobile communication terminal 100 according to the embodiment of the present invention.

Referring to FIGS. 1 and 2, in the mobile communication terminal 100, an optical zoom camera lens module 102 is deployed on a lower part of a main body, and on one side 103 of the main body are deployed camera operation keys, such as a camera power key 141, which is used to enter a camera mode, a zoom key 142, which is used to control zoom levels such as zoom magnification of a camera lens module 102, and a shutter key 143, which is used to capture an image.

The camera lens module 102 is a zoom lens portion in which zoom levels are adjusted and moves outward and inward by the zoom key 142. In the zoom key 142, “W” is an abbreviation to denote “WIDE,” and “T” is an abbreviation to denote “TELE.” When a user selects a camera mode, the mobile communication terminal 100 initially enters a wide state (i.e., a 0 level of the zoom magnification) in a preview state. If the user pushes a “T” key in the wide state, an image is positively magnified or zoomed in, and in general, the zoom levels are divided into 6 or 7 levels. However, it should be appreciated by those skilled in the art that the present invention is not limited to 6 or 7 levels.

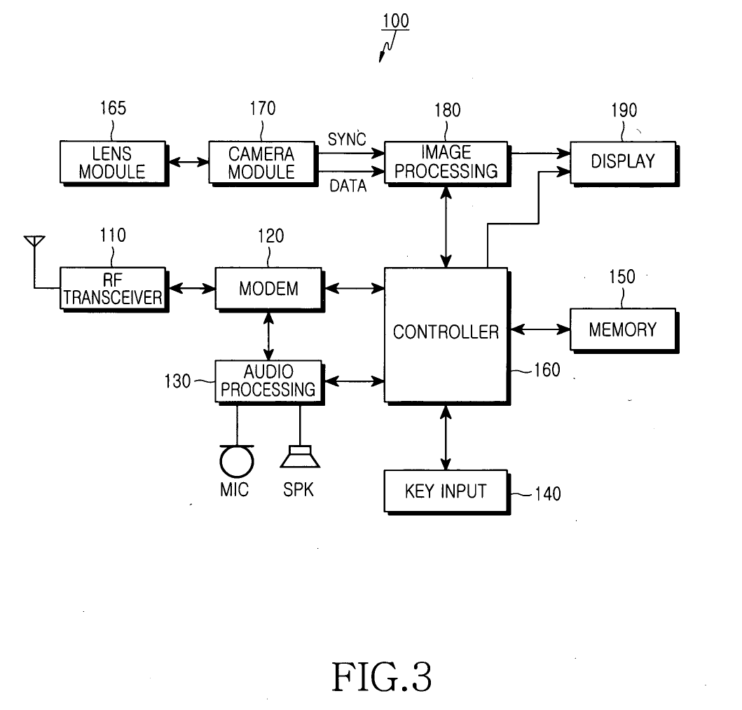

FIG. 3 is a schematic block diagram of the mobile communication terminal 100 according to the embodiment of the present invention.

The mobile communication terminal 100 includes a radio frequency (RF) transceiver 110, a modem 120, an audio processing unit 130, a key-input unit 140, a memory 150, a controller 160, a lens module 165, a camera module 170, an image processing unit 180, and a display unit 190.

The RF transceiver 110 transmits/receives voice data, character data, image data, and control data under the control of the controller 160, and comprises a RF transmitter (not shown) for up-converting a frequency of a transmission signal and amplifying the up-converted transmission signal, and an RF receiver (not shown) for low-noise-amplifying a received signal and down-converting a frequency thereof.

The modem 120 includes a transmitter for encoding and modulating the transmission signal, and a receiver for demodulating and decoding the received signal.

The audio processing unit 130 may include a codec, which includes a data codec for processing packet data and an audio codec for processing an audio signal such as voice.

The audio processing unit 130 modulates an electrical signal input from a microphone MIC to audio data and demodulates encoded audio data input from the RF transceiver 110 into an electrical signal and outputs the electrical signal to a speaker SPK. The audio processing unit 130 preferably includes a codec for converting a digital audio signal received from the RF transceiver 110 to an analog audio signal and converting an analog audio signal generated by the microphone MIC to a digital audio signal. The codec includes a data codec for processing packet data and an audio codec for processing an audio signal such as voice. Alternatively, the codec may be included in the controller 160.

The key-input unit 140 has a matrix structure (not shown), comprises character keys, number keys, a plurality of function keys, and a volume key, and outputs a key input signal corresponding to a key activated by the user to the controller 160. The key-input unit 140 can comprise camera operation keys, i.e., the camera power key 141 used to enter the camera mode, the zoom key 142 used to control the zoom levels such as the zoom magnification of the camera lens module 102, and the shutter key 143 used to capture an image, disposed in a predetermined location as shown in FIG. 1.

The memory 150 can comprise a program memory and a data memory, and stores various types of information required for an operational control on the mobile communication terminal 100 and various types of information selected based on information selected by the user. The memory 150 can store programs for controlling the lens module 165 in the camera mode according to the present embodiment. In addition, the memory 150 stores table information, in which predetermined keys are matched to the zoom levels of the lens module 165, under the control of the controller 160.

TABLE 1

| | Zoom level | | | | | | |
|---|---|---|---|---|---|---|---|
| | 1 | 2 | 3 | 4 | 5 | 6 | 7 |
| Key | Number | Number | Number | Number | Number | Number | Number |
| | key 1 | key 2 | key 3 | key 4 | key 5 | key 6 | key 7 |

According to Table 1, the zoom levels are divided into 7 levels, and the first zoom level, the second zoom level, the third zoom level, the fourth zoom level, the fifth zoom level, the sixth zoom level, and the seventh zoom level are matched to the number key 1, the number key 2, the number key 3, the number key 4, the number key 5, the number key 6, and the number key 7, respectively. It is preferable that the zoom magnification gradually becomes higher from the first zoom level to the seventh zoom level, and it is preferable that numbers assigned to the number keys are stored so that the numbers indicate the zoom levels matched thereto. In the present embodiment, the zoom levels are divided into the 7 levels, but this is only one example, and it will be understood by those skilled in the art that the zoom levels are not limited to the 7 levels.

The controller 160 controls the entire operation of the mobile communication terminal 100. Further, the controller 160 controls the memory 150 to store table information in which predetermined keys (e.g., number keys) are mapped to the zoom levels of the lens module 165. Here, it is preferable that the controller 160 controls the memory 150 to store the numbers assigned to the number keys so that the numbers are mapped to the zoom levels.

If any one of the predetermined keys (e.g., number keys) stored in the memory 150 is input when the mobile communication terminal 100 is in the camera mode, the controller 160 controls the zoom magnification to be a zoom level corresponding to the input key. That is, if the number key 5 is input through the key-input unit 140, the controller 160 controls the zoom magnification to be the fifth zoom level.

If the shutter key 143 for capturing image data in the camera module 170 is activated, the controller 160 controls the camera module 170 to capture the image data in the controlled zoom level (i.e., the zoom magnification).

The camera module 170 includes the lens module 165 that can be pulled out and retracted and captures image data through the lens module 165.

The camera module 170 includes a camera sensor, which converts a captured optical signal to an electrical signal, and a signal processing unit, which converts an analog image signal output from the camera sensor to digital data.

Here, it is assumed that the camera sensor is a charge coupled device (CCD), and the signal processing unit can be realized using a digital signal processor (DSP). The camera sensor and the signal processing unit can be realized in one body or separately.

The image processing unit 180 generates screen data to display the image signal output from the camera module 170.

The image processing unit 180 processes the image signal output from the camera module 170 on a per-frame basis and outputs the processed frame image data according to characteristics of the display unit 190 and the size of a screen of the display unit 190. The image processing unit 180, comprising an image codec, encodes the frame image data to be displayed on the display unit 190 in a predetermined method, and decodes the encoded frame image data to the original frame image data.

Here, it is assumed that the image processing unit 180 has an on-screen display (OSD) function, and the image processing unit 180 can output OSD data according to the size of the screen under the control of the controller 160.

The display unit 190 can comprise a liquid crystal display (LCD), and outputs various kinds of display data generated by the mobile communication terminal 100. If the LCD is realized with a touch screen scheme, the display unit 190 can serve as an input unit.

The display unit 190 displays the frame image data output from the image processing unit 180 and user data output from the controller 160 on the screen.

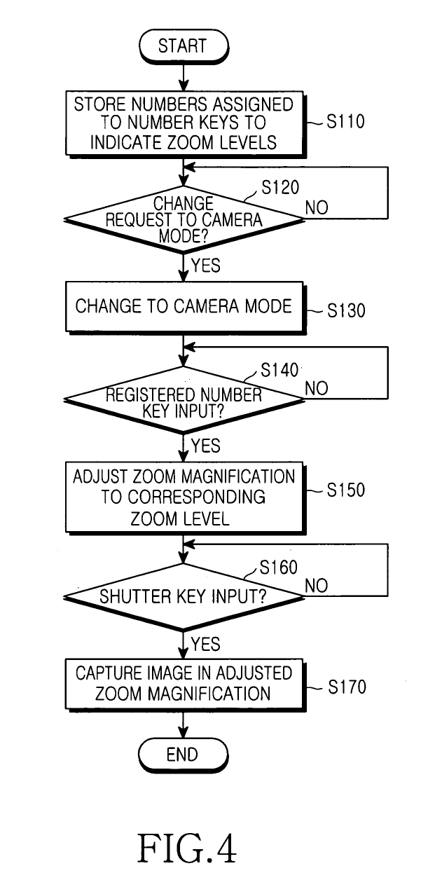

FIG. 4 is a flowchart illustrating a process of controlling a zoom function of the mobile communication terminal 100 according to an embodiment of the present invention.

Referring to FIGS. 3 and 4, the controller 160 stores predetermined keys (e.g., number keys) corresponding to zoom levels of the lens module 165 in the memory 150 in a format of a table in step S110. Here, when the controller 160 registers the number keys such that the number keys are uniquely matched to the zoom levels of the camera module 170, it is preferable that numbers assigned to the number keys are registered in the table so that the numbers indicate the zoom levels assigned thereto.

In step S120, the controller 160 determines whether a mode change request to enter the camera mode (e.g., the mode change request to the camera mode using a voice input, a key input set for a change to the camera mode, or a menu key input) is input by the user. If the mode change request to enter the camera mode is input, the controller 160 changes the mobile communication terminal 100 to the camera mode in step S130.

In step S140, the controller 160 determines whether a number key (i.e., a number key registered in the table) stored in the memory 150 is input.

If any one of the number keys registered in the table is input, the controller 160 adjusts the zoom magnification to a zoom level corresponding to the input number key in step S150. For example, if the number key 3 to which a number of 3 is assigned is input through the key-input unit 140, the controller 160 controls the zoom magnification to the third zoom level.

In step 160, the controller 160 determines whether the shutter key 143 for capturing image data in the camera module 170 is activated by the user. If the shutter key 143 is activated, the controller 160 controls the camera module 170 to capture the image data in the controlled zoom magnification in step SI 70.

According to the embodiment of the present embodiment, the user of the mobile communication terminal 100 can easily control the zoom magnification by pushing a number key without continuously pushing a zoom control key in the camera mode, and the zoom control can be performed by pushing number keys without a separate key for the zoom control.

As described above, according to the embodiment of the present invention, a user can easily control a zoom magnification by pushing a number key once without having to continuously push a zoom control key in a camera mode of a mobile communication terminal.

Moreover, in a mobile communication terminal having a camera, a zoom control can be performed by pushing number keys basically used in the mobile communication terminal without a separate key for the zoom control.

While the invention has been shown and described with reference to a certain embodiment thereof, it will be understood by those skilled in the art that various changes in form and details may be made therein without departing from the spirit and scope of the invention as defined by the appended claims.

What is claimed is:

1. A method for controlling a zoom function of positively or negatively magnifying an image in a mobile communication terminal having a camera, the method comprising the steps of:
registering predetermined keys such that the keys are uniquely mapped to zoom levels of the camera; and
if any one of the registered keys is input in a camera mode of the mobile communication terminal, adjusting a zoom magnification to a zoom level corresponding to the input key.

2. The method of claim 1, wherein the predetermined keys are number keys included in a keypad of the mobile communication terminal.

3. The method of claim 1, wherein in the registering step comprises the step of registering the number keys such that numbers uniquely assigned to the number keys indicate the zoom levels.

4. The method of claim 2, wherein in the registering step comprises the step of registering the number keys such that numbers uniquely assigned to the number keys indicate the zoom levels.

5. The method of claim 1, wherein the keys are disposed on a screen.

6. The method of claim 1, wherein the screen comprises a liquid crystal display.

7. The method of claim 1, wherein the screen comprises an input unit.

8. The method of claim 1, wherein a correlation between the zoom settings and keys are stored in a table.

9. The method of claim 1, wherein the table comprises seven levels.

10. A mobile communication terminal having a camera comprising:
a camera module including a retractable lens module, for capturing image data through the lens module;
a memory for storing table information in which predetermined keys are uniquely mapped to zoom levels of the lens module; and
a controller for, if any one of the predetermined keys stored in the memory is input in a camera mode, adjusting a zoom magnification to a zoom level corresponding to the input predetermined key.

11. The mobile communication terminal of claim 10, wherein the predetermined keys are number keys included in a keypad of the mobile communication terminal.

12. The mobile communication terminal of claim 10, wherein the memory stores table information such that numbers uniquely assigned to the number keys indicate the zoom levels, under the control of the controller.

13. The mobile communication terminal of claim 10, wherein the table comprises seven levels.

14. The mobile communication terminal of claim 10, further comprising a display unit.

15. The mobile communication terminal of claim 14, wherein the display unit comprises a liquid crystal display.

16. The mobile communication terminal of claim 10, wherein the screen comprises an input unit.

17. The mobile communication terminal of claim 10, wherein the predetermined keys are separate from a dedicated zoom key.
